(19) United States
(12) Patent Application Publication
(10) Pub. No.: US 2016/0364400 A1
(43) Pub. Date: Dec. 15, 2016

(54) MANAGEMENT SERVER WHICH OUTPUTS FILE RELOCATION POLICY, AND STORAGE SYSTEM

(71) Applicant: Hitachi, Ltd., Tokyo (JP)

(72) Inventors: Naoki Isomura, Tokyo (JP); Katsutoshi Asaki, Tokyo (JP); Junichi Hara, Tokyo (JP); Takato Kusama, Tokyo (JP)

(21) Appl. No.: 15/120,836

(22) PCT Filed: Jun. 13, 2014
(86) PCT No.: PCT/JP2014/065760

§ 371 Date: Aug. 23, 2016

(51) Int. Cl. G06F 17/30; G06F 3/06

(52) U.S. Cl. CPC G06F 17/30138; G06F 3/0613; G06F 3/0643; G06F 3/0647; G06F 3/067; G06F 17/30194

(57) ABSTRACT

It is provided a management server comprising a memory, a processor configured to access to the memory, and a network interface through which the management server holds communication to/from a storage apparatus and a file server. The storage apparatus includes a storage device, which is divided into pages each having a determined capacity to store data. The file server is configured to manage, on a file-by-file basis, data that is stored in the storage apparatus. The processor is configured to: obtain an I/O count per unit time of access to pages which stores data contained in the file; and compare a policy applied to the file and imbalance in I/O to a part of the data contained in the file, and output a changed policy in the case where it is found that the policy applied to the file needs to be changed as a result of the comparison.

### BACKGROUND

This invention relates to a management server configured to manage a storage system.

Block storage hierarchization is a technology for enhancing the utilization efficiency of a block storage apparatus. The block storage hierarchization technology uses storage devices of a plurality of types different from one another in performance to form a tiered pool, and allocates real storage areas (also called real areas) amassed in the tiered pool to virtual logical volumes. In a tiered storage technology, the storage location of data of a logical volume is changed automatically or manually to a tier of appropriate performance based on an input/output (I/O) load that is incurred by the data. A storage capacity necessary for a particular piece of data can be allocated from a storage device that has performance necessary for the data by utilizing the tiered storage technology.

Background art of the technical field of this invention includes JP 2010-108341 A, JP 2011-70628 A, and WO 2011/117925 A1.

In JP 2010-108341 A, there is described a storage system that includes storage devices of a plurality of types different from one another in performance. The storage system has pools of a plurality of types which are created from a plurality of storage devices and each of which belongs to a different tier. Each pool is made up of one or more storage devices of the same type, and the type of the storage device(s) corresponds to the type of the pool. In the case where a given storage location changing condition is met, a controller in the storage system executes storage location changing processing to change the storage location of target data stored in a target first real page, which is allocated to a virtual page in a virtual volume, to a second real page, which is an unallocated page in a Type 2 pool different in type from a Type 1 pool where the target first real page is stored. The size of a real page varies from one pool type to another.

A storage system described in JP 2011-70628 A includes a pool created from physical storage volumes each of which is divided into a plurality of tiers of different tier levels, and a controller. The controller in the storage system allocates the pool to a plurality of virtual volumes. The controller stores, for each application software running on a host computer, a relation between data in the storage system that is accessed by the application software and the application ID of the application software. The tier levels of each storage volume are changed based, at least partially, on application software that accesses data in the storage volume.

File server hierarchization, on the other hand, is a technology for enhancing the utilization efficiency of a file server. The file server hierarchization technology uses logical volumes of a plurality of types different from one another in performance to form a file system, and allocates files to the volumes. The association relation between a file and a volume is changed automatically or manually by a policy-based hierarchization technology. Conditions for narrowing down files such as a file name and the date/time of creation and a logical volume where the file in question is placed are written in a policy. A management program of a file server refers to the policy to allocate a file to a logical volume.

Attempts have been made to raise utilization efficiency by combining file server hierarchization and block storage hierarchization. However, no effective technology has been established yet.

In WO 2011/117925 A1, for example, a storage management system compares the required response performance of a file and the response performance of a pool volume that is allocated to a page, when the required response performance of the file is added to an access request from a host computer. In the case where the compared response performance of the pool volume falls short of the required response performance, the storage management system selects a pool volume having response performance that matches the required response performance, migrates the page to the selected pool volume, and stores data in the page to which the pool volume is allocated.

### SUMMARY

The related art described in JP 2010-108341 A and JP 2011-70628 A considers only relocation by block storage and not relocation by a file server. The related art described in WO 2011/117925 A1 considers relocation by a file server and relocation by block storage both, but gives no thought to an environment where a file system is made up of a plurality of logical volumes and relocation takes place on a file server.

The utilization efficiency of an upper tier can therefore be raised by combining relocation by a file server and relocation by block storage. However, simply combining the related art described above does not accomplish optimum data placement. For instance, applying relocation by a file server to a file that is partially accessed frequently places the whole file in an upper tier, which may not optimize the utilization efficiency of upper tiers.

It is also difficult for an administrator to find, for every file, a problematic relocation policy of the file server. Another problem is that I/O access imbalance, a change of a hot spot, and other types of information necessary for the administrator to evaluate a relocation policy are not presented appropriately.

In order to solve the problems described above, a problematic relocation policy needs to be presented to the administrator in a recognizable manner and information necessary to evaluate a relocation policy needs to be presented to the administrator as well.

The representative one of inventions disclosed in this application is outlined as follows. There is provided a management server comprising a memory, a processor configured to access to the memory, and a network interface through which the management server holds communication to/from a storage apparatus and a file server. The storage apparatus includes a storage device, which is divided into pages each having a determined capacity to store data. The file server is configured to manage, on a file-by-file basis, data that is stored in the storage apparatus. The processor obtains an I/O count per unit time of access to pages which stores data contained in the file, compares a policy applied to the file and imbalance in I/O to a part of the data contained in the file, and outputs a changed policy in the case where it is found that the policy applied to the file needs to be changed as a result of the comparison.

According to the exemplary embodiment of this invention, the utilization efficiency of a storage device can be enhanced in an environment where file server hierarchization and block storage hierarchization are combined. Other objects, configurations, and effects than those described above are revealed in the description of embodiments of this invention given below.

### BRIEF DESCRIPTION OF THE DRAWINGS

FIG. 1 is a diagram for illustrating a configuration of a computer system according to a first embodiment.

FIG. 2 is a diagram for illustrating a hardware configuration of a file server.

FIG. 3 is a diagram for illustrating a hardware configuration of a management server.

FIG. 4 is a diagram for illustrating a hardware configuration of a storage apparatus.

FIG. 5 is a diagram for illustrating logical configurations of the file server and the storage apparatus.

FIG. 6 is a diagram for illustrating an example of a configuration of RAID group management information.

FIG. 7 is a diagram for illustrating an example of a configuration of real area management information.

FIG. 8 is a diagram for illustrating an example of a configuration of virtual volume management information.

FIG. 9 is a flow chart of data relocation processing of block storage.

FIG. 10 is a diagram for illustrating an example of a configuration of file management information.

FIG. 11 is a diagram for illustrating an example of a configuration of file server configuration information.

FIG. 12 is a diagram for illustrating an example of a configuration of policy settings information.

FIG. 13 is a flow chart of file relocation control processing.

FIG. 14 is a flow chart of processing of obtaining a relocation destination of a file.

FIG. 15 is a diagram for illustrating an example of a configuration of problematic policy management information.

FIG. 16 is a diagram for illustrating an example of a configuration of file-based page access imbalance information.

FIG. 17 is a diagram for illustrating an example of a configuration of feature amount and threshold information.

FIG. 18 is a diagram for illustrating an example of a configuration of page access imbalance (policy-based) time-series information.

FIG. 19 is a diagram for illustrating an example of a configuration of page access imbalance (file-based) time-series information.

FIG. 20 is a diagram for illustrating an example of a configuration of virtual volume management information (for management).

FIG. 21 is a flow chart of problematic policy searching processing.

FIG. 22 is a flow chart of page access imbalance obtaining processing.

FIG. 23 is a flow chart of processing of obtaining page access imbalance of a file.

FIG. 24 is a flow chart of processing of calculating page access imbalance.

FIG. 25 is a diagram for illustrating an example of a screen on which problematic policies is presented to a user.

FIG. 26 is a diagram for illustrating an example of a configuration of hot spot information according to a second embodiment.

FIG. 27 is a flow chart of hot spot change obtaining processing.

FIG. 28 is a diagram for illustrating an example of a screen on which policies is presented to the user according to a third embodiment.

### DETAILED DESCRIPTION OF THE PREFERRED EMBODIMENTS

Now, referring to the accompanying drawings, a description is given of the embodiments of this invention. In the accompanying drawings, components that are functionally the same are sometimes denoted by the same reference symbols. The accompanying drawings are illustrations of specific embodiments and implementation examples in conformity with the principle of this invention, but those are used for the understanding of this invention and never used to limit the interpretation of this invention.

In the embodiments of this invention, the description thereof is made in detail enough for a person skilled in the art to carry out this invention, but it is necessary to understand that other implementations and modes are possible and that changes in configurations and structures and substitutions of diverse components can be made without departing from the scope and spirit of the technical idea of this invention. Therefore, the following description should not be interpreted to be limited thereto.

Further, as described later, the embodiments of this invention may be implemented by software running on a general purpose computer, by dedicated hardware, or by a combination of software and hardware.

In the following description, each piece of information of this invention is described by using the “table” form, but those pieces of information do not necessarily need to be expressed by the data structure based on the table, and may be expressed by data structures such as a list, a DB, and a queue, or in other such form. For that reason, “table”, “list”, “DB”, and the like are sometimes referred to simply as “information” in order to indicate independence of the data structure.

Further, the expressions “identification information”, “identifier”, “name”, and “ID” can be used in order to describe details of each piece of information, and those expressions can be substituted with one another.

The following description is made of each processing according to the embodiments of this invention by using a “program” as a subject (operation subject), but may be made by using a processor as the subject because the program performs predetermined processing by being executed by the processor while using a memory and a communication port (communication control device). Further, the processing disclosed by using the program as the subject may also be the processing performed by a computer, e.g., a management server, or an information processing apparatus. A part or an entirety of the program may be realized by dedicated hardware or may be modularized. The programs may be installed in respective computers through a program distributing server or storage media.

The invention disclosed in this patent application relates to a storage management technology for optimizing the utilization of storage devices in a storage apparatus, and is particularly effective in an environment where a hierarchization technique in a file server and a hierarchization technique in a block storage are used in combination.

### First Embodiment

A file server in a first embodiment of this invention includes virtual volumes that are built in a storage apparatus and that are allocated from a plurality of pools each having a plurality of storage tiers different from one another in performance. In an example described here, a management server identifies a problematic policy based on policy settings information 113 of the file server and a page access count, and presents the problematic policy to a user.

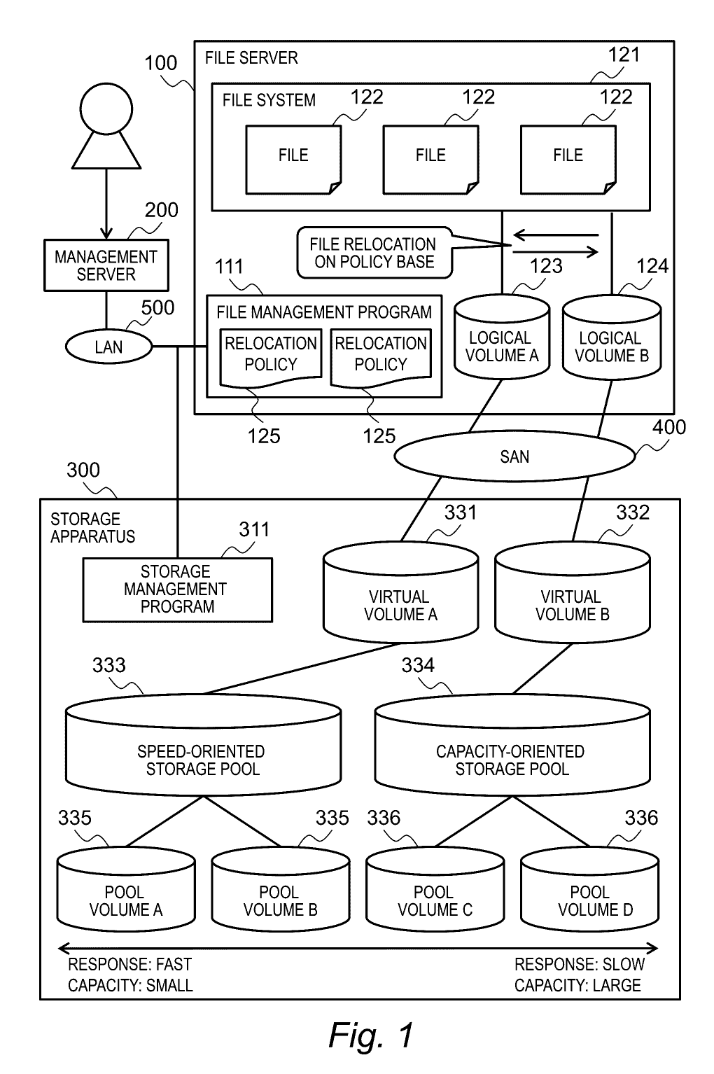

FIG. 1 is a diagram for illustrating the configuration of a computer system according to the first embodiment.

The computer system includes a file server 100, a management server 200, and a storage apparatus 300. The file server 100 and the storage apparatus 300 are coupled to each other by a storage area network (SAN) 400. The file server 100, the management server 200, and the storage apparatus 300 are coupled to one another by a local area network (LAN) 500.

The file server 100 is set up at the back end of a server (not shown) (for example, a Web server), and provides a file system 121 to this server. The file server 100 may also provide the file system 121 to a terminal (not shown).

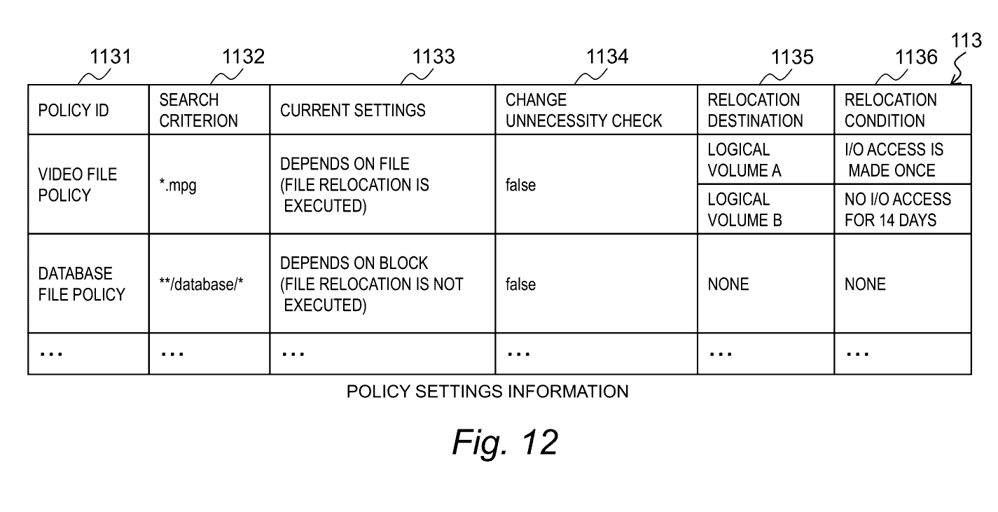

Files 122 provided by the file system 121 are stored in logical volumes 123 and 124, which are provided by the storage apparatus 300. The logical volumes 123 and 124 differ from each other in performance. The logical volume 123, which is a logical volume A, has high response performance, and the logical volume 124, which is a logical volume B, has low response performance. A file management program 111 relocates a file between the logical volume A 123 and the logical volume B 124 by following a file relocation policy 125 that is read out of the policy settings information 113 shown in FIG. 12.

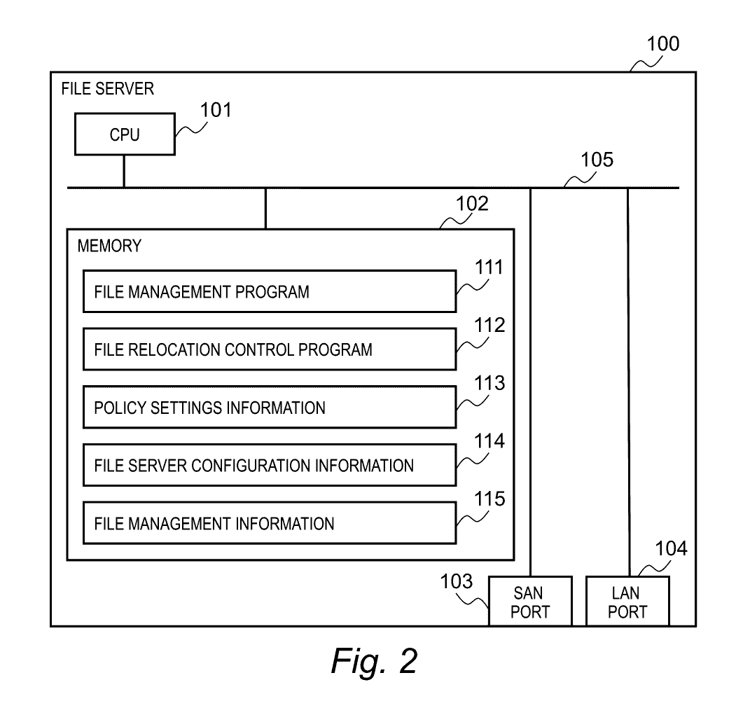

Details of the configuration of the file server 100 are described later with reference to FIG. 2.

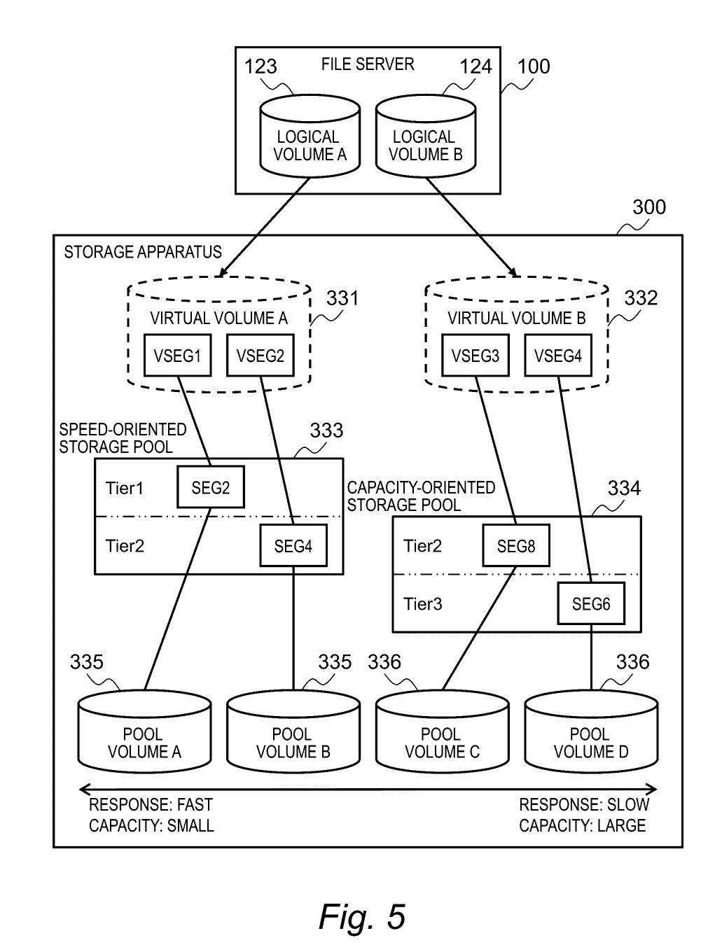

The storage apparatus 300 provides virtual volumes 331 and 332 by way of a storage management program 311. The virtual volumes 331 and 332, storage pools 333 and 334, and pool volumes 335 and 336 are described later with reference to FIG. 5.

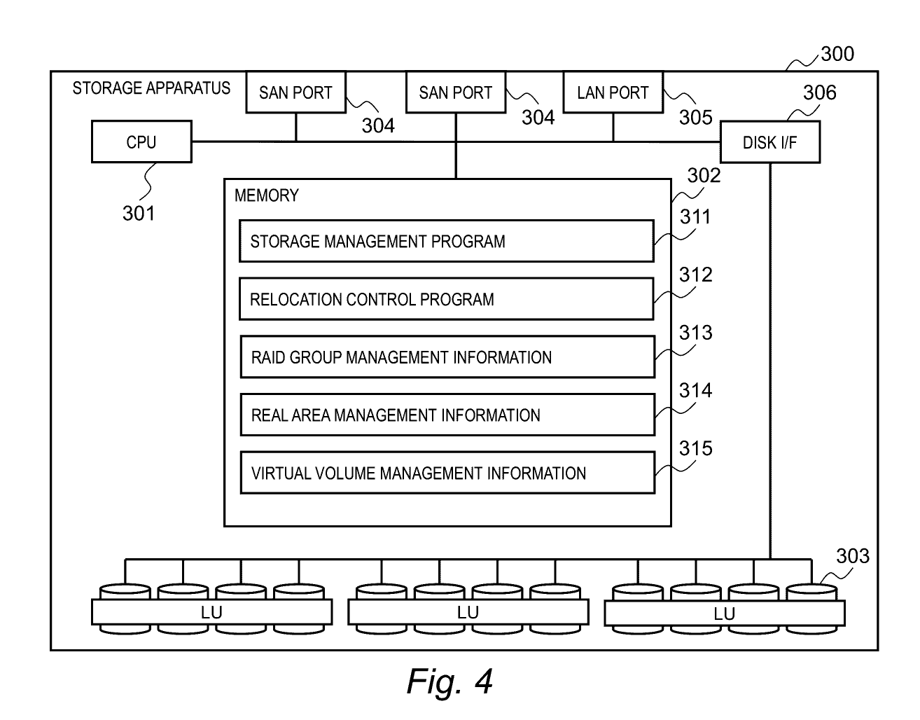

Details of the configuration of the storage apparatus 300 are described later with reference to FIG. 4.

(i) File Server

FIG. 2 is a diagram for illustrating the hardware configuration of the file server 100.

The file server 100 includes a processor (CPU) 101, a memory 102, a SAN port 103, and a LAN port 104. The CPU 101, the memory 102, the SAN port 103, and the LAN port 104 are coupled to one another by a bus 105. The SAN port 103 couples the file server 100 to the SAN 400. The LAN port 104 couples the file server 100 to the LAN 500.

The CPU 101 executes various types of processing by executing the file management program 111 and a file relocation control program 112, which are stored in the memory 102.

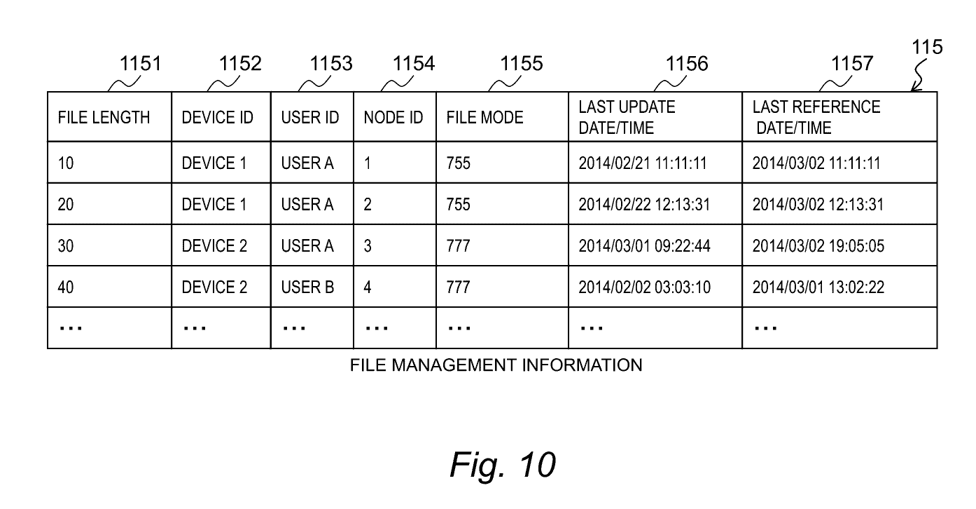

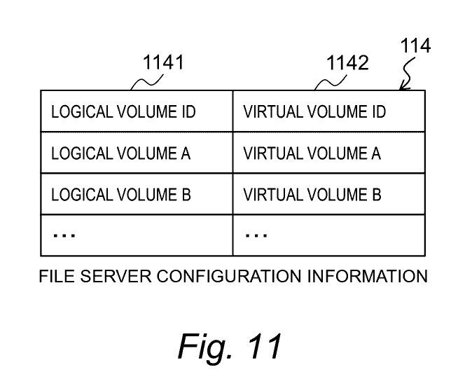

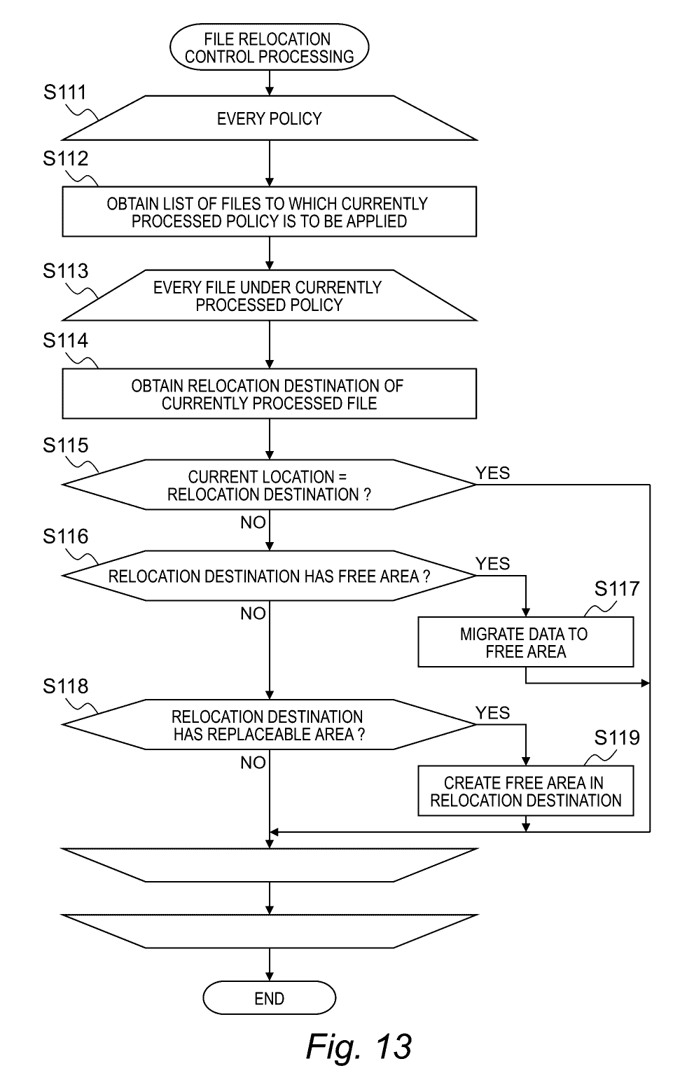

The memory 102 stores the file management program 111 and the file relocation control program 112 illustrated in FIG. 13. The memory 102 also stores information necessary for the CPU 101 to execute the file management program 111 and the file relocation control program 112. For example, the memory 102 stores the policy settings information 113 shown in FIG. 12, file server configuration information 114 shown in FIG. 11, and file management information 115 shown in FIG. 10. The file relocation control program 112 executes file relocation control processing regularly, for example at given time intervals, e.g., once in 10 minutes

(ii) Management Server

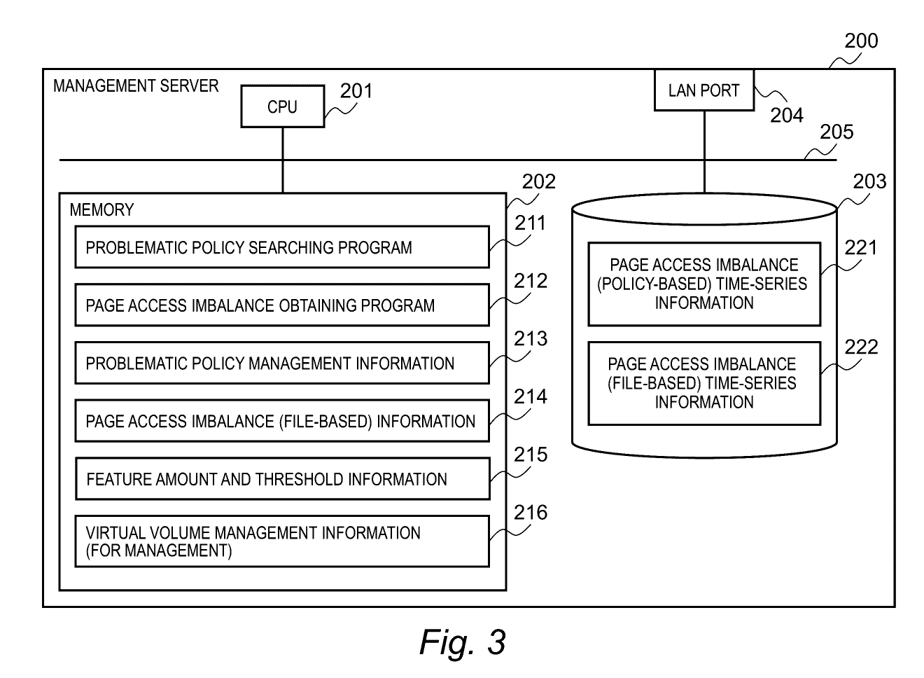

FIG. 3 is a diagram for illustrating the hardware configuration of the management server 200.

The management server 200 includes a processor (CPU) 201, a memory 202, an auxiliary storage device 203, and a LAN port 204. The CPU 201, the memory 202, the auxiliary storage device 203, and the LAN port 204 are coupled to one another by a bus 205. The LAN port 204 couples the management server 200 to the LAN 500.

The CPU 201 executes various types of processing by executing a problematic policy searching program 211 and a page access imbalance obtaining program 212, which are stored in the memory 202.

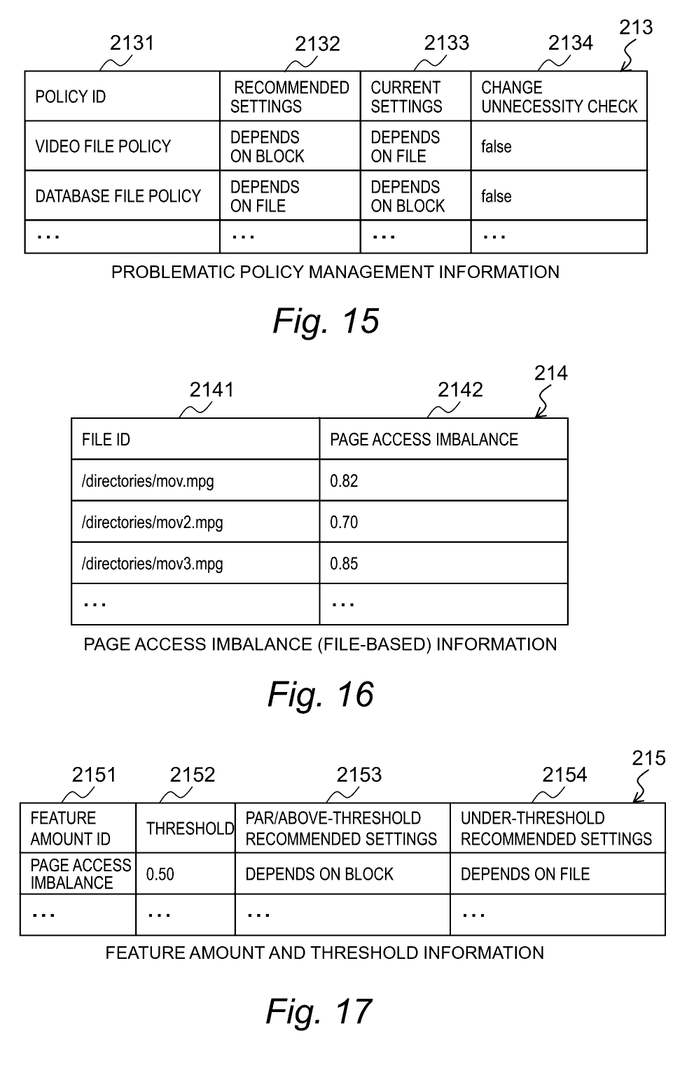

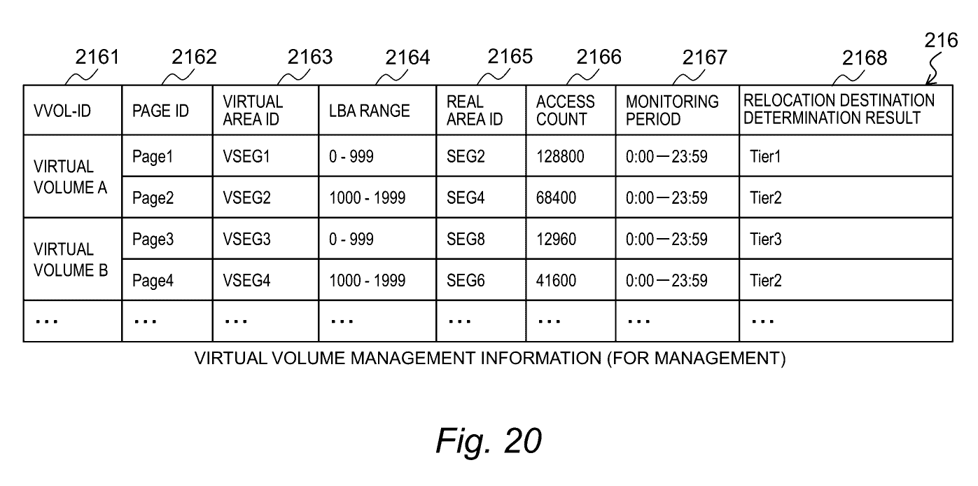

The memory 202 stores the problematic policy searching program 211 and the page access imbalance obtaining program 212. The memory 202 also stores information necessary for the CPU 201 to execute the problematic policy searching program 211 and the page access imbalance obtaining program 212. For example, the memory 202 stores problematic policy management information 213 shown in FIG. 15, page access imbalance (file-based) information 214 shown in FIG. 16, feature amount and threshold information 215 shown in FIG. 17, and virtual volume management information (for management) 216 shown in FIG. 20.

The problematic policy searching program 211 obtains, for example, the policy settings information 113, which is held in the file server 100, executes problematic policy searching processing, and creates the problematic policy management information 213. The problematic policy searching program 211 also calls up the page access imbalance obtaining program 212 to obtain page access imbalance. Details of the processing procedures are described later.

The page access imbalance obtaining program 212 executes processing of obtaining page access imbalance of a file that is being processed, processing of storing the obtained page access imbalance in page access imbalance (file-based) time-series information 222, processing of calculating page access imbalance from sorted access counts and a total access count S, processing of calculating an average value of the feature amounts of all files to which a policy that is being processed applies, and processing of storing the calculated average value in page access imbalance (policy-based) time-series information 221.

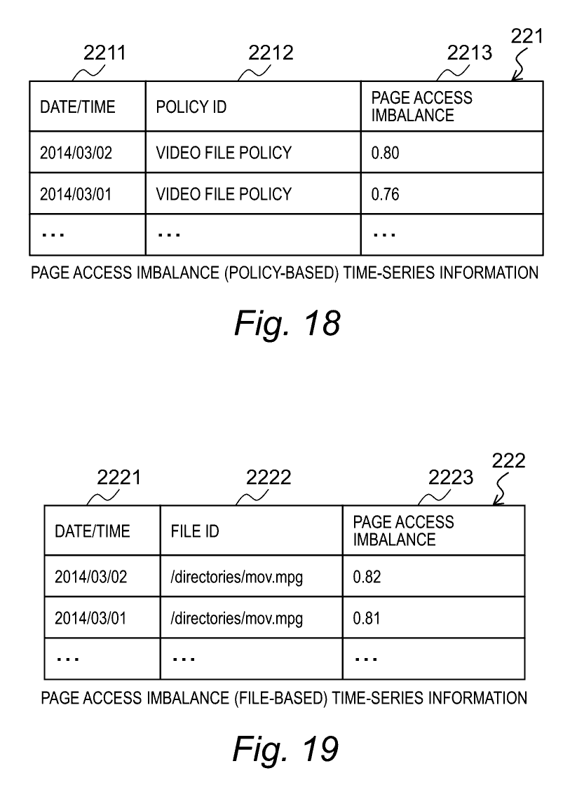

The auxiliary storage device 203 is configured to store information that is collected and managed by the page access imbalance obtaining program 212. For example, the auxiliary storage device 203 stores the page access imbalance (policy-based) time-series information 221 shown in FIG. 18 and the page access imbalance (file-based) time-series information 222 shown in FIG. 19. The auxiliary storage device 203, which is a single storage device in FIG. 4, may be made up of a plurality of storage devices. The auxiliary storage device 203 can be, for example, a SATA disk, an FC disk, or an SSD.

The management server 200 may include, though not shown, an input apparatus and a display apparatus (an output apparatus). Instead of including an input apparatus and an output apparatus in the management server 200, a terminal apparatus including a display apparatus (a display) and an input apparatus (a keyboard and a pointer device) may be coupled to a serial interface or an Ethernet interface. The management server 200 in this case transmits a display screen to the terminal apparatus, and receives input data from the terminal apparatus.

In the following description, a computer or an aggregation of computers configured to manage the computer system and displays display information in this embodiment may be referred to as “management system”. The management system may be the single management server 200 when displaying the display information. Alternatively, a management terminal configured to display the display information may be provided separately from the management server 200. In the latter case, the management system is the combination of the management server 200 and the management terminal. The management terminal may be configured to execute a program (for example, dedicated application) for displaying the display information (for example, a Web browser), or may be configured to execute a program for displaying the display information by analyzing information that is output from the management server 200. The functions of the management server 200 may be implemented by a plurality of computers in order to increase the speed and reliability of management processing. The management system in this case is the plurality of computers (including the management terminal in the case where information is displayed by a display-use computer).

(iii) Storage Apparatus

FIG. 4 is a diagram for illustrating the hardware configuration of the storage apparatus 300.

The storage apparatus 300 includes a processor (CPU) 301, a memory 302, at least one physical storage device 303, SAN ports 304, and a LAN port 305, and a disk interface 306. The CPU 301, the memory 302, the physical storage device 303, the SAN ports 304, the LAN port 305, and the disk interface 306 are coupled to one another by a bus 307. The SAN ports 304 couple the storage apparatus 300 to the SAN 400. The LAN port 305 couples the storage apparatus 300 to the LAN 500.

The CPU 301 executes various types of processing by executing a storage management program 311, which is stored in the memory 302.

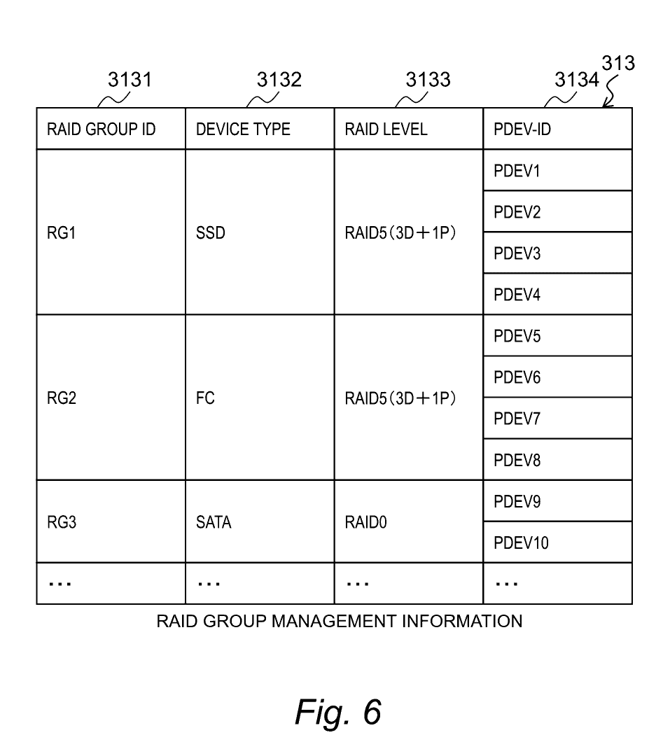

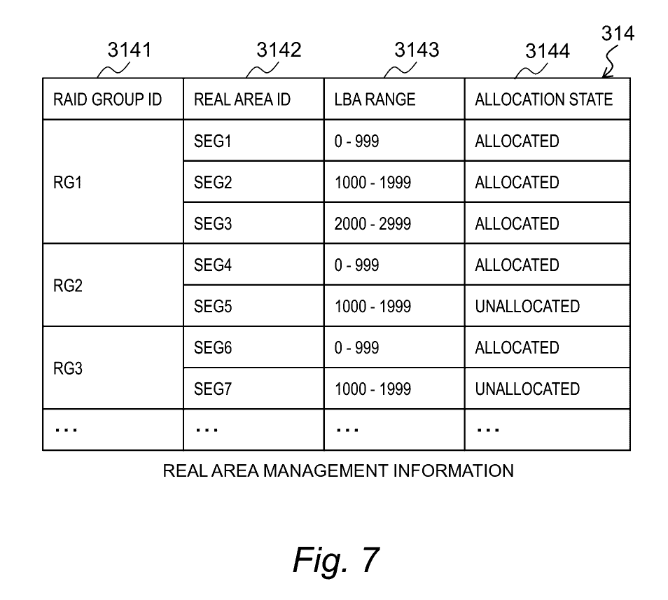

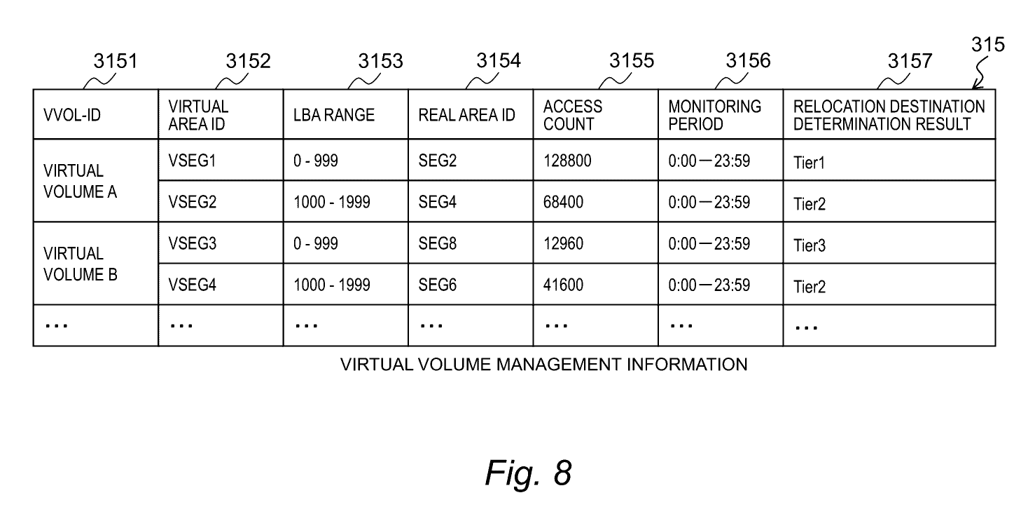

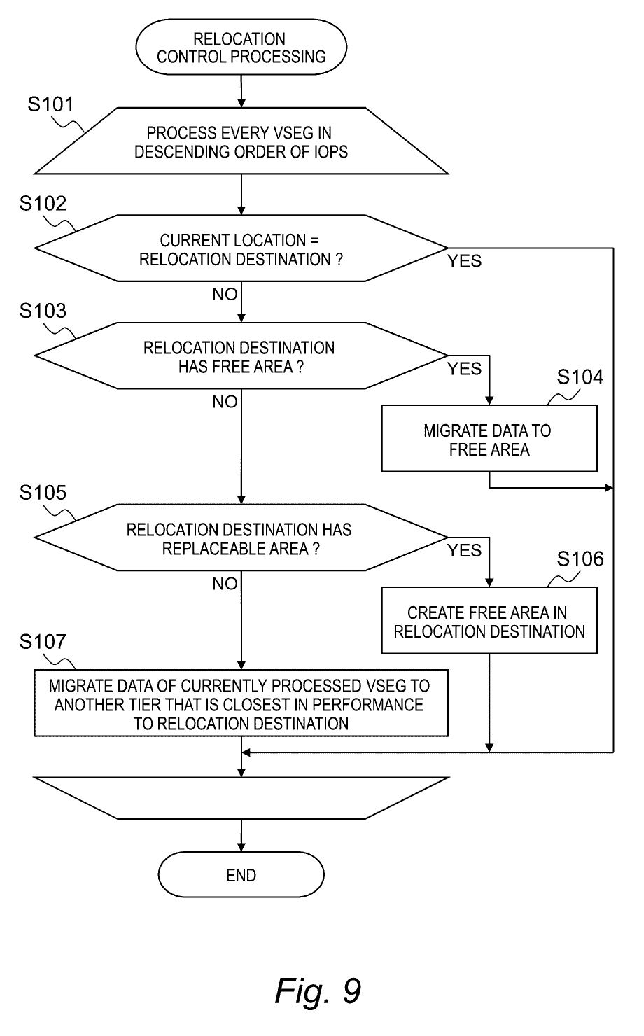

The memory 302 stores the storage management program 311, a relocation control program 312 (processing executed by this program is illustrated in FIG. 9), and information necessary for the CPU 301 to execute the storage management program 311 and the relocation control program 312. For example, the memory 302 stores RAID group information 313 shown in FIG. 6, real area management information 314 shown in FIG. 7, and virtual volume management information 315 shown in FIG. 8. The storage management program 311 executes, for example, processing of building logical volumes that are provided logically by the storage apparatus 300.

The physical storage device 303 provides physical storage areas treated as storage areas. The physical storage device 303 is, for example, an SATA disk, an FC disk, or an SSD.

<Configuration Example of Logical Storage Areas>

FIG. 5 is a diagram for illustrating the logical configurations of the file server 100 and the storage apparatus 300.

The storage management program 311 has a function of creating logical storage areas from a plurality of physical storage devices 303. For example, the storage management program 311 can create logical storage areas such as RAID groups, logical volumes, storage pools, and virtual volumes. The different types of logical storage areas are described in detail below.

RAID groups are logical storage areas created from a plurality of physical storage devices 303, namely, redundant arrays of inexpensive disks (RAID) built by the storage management program 311. For example, the storage management program 311 receives an instruction about which of the plurality of physical storage devices 303 is to be used to form a RAID group and the specification of a RAID level as input parameters from the management server 200, and builds a RAID group that has the specified RAID level from the specified physical storage device 303. RAID groups can have various sizes, and a mixture of RAID groups varied in size can be set here.

A logical volume is a logical storage area inside a RAID group and is created by the storage management program 311. For example, the storage management program 311 receives the specification of a RAID group from which a logical disk is to be created and the size of the logical volume as input values from the management server 200, and creates a logical volume that has the specified size from the specified RAID group.

The storage pools 333 and 334 are each a logical storage area created from a plurality of logical volumes by the storage management program 311. For example, the storage management program 311 receives the specification of a plurality of logical volumes from which a pool is to be created as an input value from the management server 200, and creates the storage pool 333 or 334 from the specified plurality of logical volumes. Logical volumes from which the storage pools 333 and 334 are created are referred to as “pool volumes” in the following description, and written as “pool volumes” in the drawings.

A real area (segment: SEG) is a storage area created from one or more logical storage areas that make up a storage pool, and is created by the storage management program 311. A SEG can be expressed as a “page” to describe the SEG. Data stored in a SEG is stored, via a storage pool from which the page of the SEG is created, in a logical volume from which the storage pool is created.

The virtual volumes 331 and 332 are each a logical storage area that is created from a plurality of virtual areas (virtual segments: VSEGs) by the storage management program 311, and that is provided to the file server 100 as a virtual volume having a larger capacity than the actual capacity. For example, the storage management program 311 receives the specification of the capacity of a virtual volume as an input value from the management server 200, and creates a virtual volume that has the specified capacity from a plurality of SEGs. The storage management program 311 also provides the virtual volumes 331 and 332, which are volumes having a larger capacity than the actual capacity, to the file server 100 as the logical volumes 123 and 124. While logical volumes and virtual volumes are associated with each other on a one-to-one basis in FIG. 5, one logical volume may be associated with multiple virtual volumes, and multiple logical volumes may be associated with one virtual volume.

The virtual volumes 331 and 332 are associated with the storage pools 333 and 334, respectively. In the case where, for example, data from the file server 100 is written to VSEG1 inside the virtual volume 331, which is a virtual volume A, SEG2 selected from the storage pool 333 is allocated to the virtual volume 331. The data from the file server 100 is written to the allocated real area SEG2.

The storage pools 333 and 334 each have a plurality of storage tiers different from one another in performance. For example, the storage pool 333 has a first tier (Tier 1) and a second tier (Tier 2), and the storage pool 334 has the second tier (Tier 2) and a third tier (Tier 3).

The first tier is created from real areas inside storage devices that have the highest performance. The first tier can also be called a top tier. The second tier is created from real areas inside storage devices that have intermediate performance. The second tier can also be called an intermediate tier. The third tier is created from real areas inside storage devices that have low performance. The third tier can also be called a lower tier. In the following description, the first tier and the second tier may together be referred to as “upper tiers”.

In the case where the file server 100 writes data to an unallocated virtual area inside a virtual volume, the storage management program 311 selects a real area that belongs to one of the tiers in a storage pool, and allocates the selected real area to the VSEG to which the data is to be written. The write data from the file server 100 is then written to the selected real area.

The relocation control program 312 switches, regularly or irregularly, a real area allocated to a virtual volume to a real area in another tier, based on information about access to the real area in question (that is, information about access to a virtual area).

For example, the relocation control program 312 migrates data stored in a virtual area that is high in access frequency (the I/O count per unit time) to a high performance tier (one of the upper tiers). Data in a virtual area that is low in access frequency, on the other hand, is migrated to a low performance tier (a lower tier). This cuts short the response time of data that has high access frequency. In addition, with low access frequency data migrated from a high performance tier to a low performance tier, the high performance tier can be used efficiently.

Data relocation between tiers is hidden to the outside of the storage apparatus 300. For example, after relocation between tiers is executed, the file server 100 can still access that same data that has been stored in one VSEG in the storage apparatus 300 prior to the relocation between tiers by accessing the same VSEG.

<Outline of Processing of the Storage Apparatus>

The storage management program 311 provides a function of creating the logical storage areas described above (a logical storage area creating function), a function of allocating virtual volumes to the file server 100 (a virtual volume allocating function), and a function of allocating a SEG to a virtual volume by following an I/O command from the file server 100 (a virtual volume expanding function). The storage management program 311 also provides a function of transmitting management information in response to a request that is made by the management server 200 over the LAN 500.

The relocation control program 312 changes the association between a VSEG and a SEG based on the access frequency of the VSEG.

<Configuration Examples of Respective Types of Management Information>

The management information stored in the storage apparatus 300 is described below. The storage apparatus 300 stores in the memory 302 the RAID group management information 313, the real area management information 314, and the virtual volume management information 315.

(i) RAID Group Management Information

FIG. 6 is a diagram for illustrating an example of a configuration of the RAID group management information 313, which is used to manage information of RAID groups.

In each entry of the RAID group management information 313, a RAID group ID 3131, a device type 3132, a RAID level 3133, and a storage device ID 3134 are managed in association with one another.

The RAID group ID 3131 is an identifier for uniquely identifying a RAID group. The device type 3132 is information indicating the type of the physical storage devices 303 that make up the RAID group. The RAID level 3133 is information indicating the RAID level and combination of the RAID group. The storage device ID 3134 is identification information for identifying each of the physical storage devices 303 that make up the RAID group. The physical devices 303 in the drawings may be abbreviated as “PDEVs”.

Some of the items included in the table of FIG. 6 may be changed to other items, or new items may be added to the shown items, and the single table in FIG. 6 may be divided into a plurality of tables. The same applies to the tables (information) described below.

(i) Real Area Management Information

FIG. 7 is a diagram for illustrating an example of a configuration of the real area management information 314, which is used to manage information of real areas.

In each entry of the real area management information 314, a RAID group ID 3141, a real area ID 3142, an LBA range 3143, and an allocation state 3144 are managed in association with one another.

The RAID group ID 3141 is an identifier for uniquely identifying a RAID group. The real area ID 3142 is identification information for identifying a real area (SEG). The LBA range 3143 is the range of logical block addressing (LBA) of the RAID group that corresponds to the real area. The allocation state 3144 is information indicating whether the real area is already allocated to a virtual volume.

(iii) Virtual Volume Management Information

FIG. 8 is a diagram for illustrating an example of a configuration of the virtual volume management information 315, which is used to manage virtual volumes.

The virtual volume management information 315 includes, for each virtual volume, information about each virtual area inside the virtual volume and information about a real area allocated to the virtual area. In each entry of the virtual volume management information 315, a virtual volume ID 3151, a virtual area ID 3152, an LBA range 3153, a real area ID 3154, an access count 3155, a monitoring period 3156, and a relocation destination determination result 3157 are managed in association with one another.

The virtual volume ID (VVOL-ID) 3151 is identification information for uniquely identifying a virtual volume, and indicates an identifier recognized throughout the storage apparatus 300, instead of an identifier specified by the file server 100. The virtual area ID 3152 is identification information for identifying a virtual area (VSEG).

The LBA range 3135 is the range of LBA of the virtual volume that corresponds to the virtual area (VSEG). The real area ID 3154 is identification information for identifying a real area that is allocated to the virtual area inside the virtual volume.

The access count 3155 indicates the number of times the virtual area (VSEG) inside the virtual volume has been accessed by the file server 100 (an accumulated I/O count). The monitoring period 3156 is a period in which how many times the virtual area (VSEG) has been accessed is monitored. The storage apparatus 300 monitors the access count within a time period set as the monitoring period 3156. In the case where a value indicating a particular time period is not set as the monitoring period 3156, the storage apparatus 300 monitors the access count all the time. The storage apparatus 300 resets the value of the access count to 0 at the time the access count monitoring is started. In the case where the monitoring result in a monitoring period is not saved, the value of the access count is reset to 0 each time a fixed period elapses (for example, every 24 hours). The monitoring period may be set as a fixed value in advance, or may be an arbitrary value set by the management server 200.

The relocation destination determination result 3157 is information indicating a tier that is determined as a data relocation destination through relocation processing.

FIG. 9 is a flow chart of data relocation processing of block storage. The data relocation processing is executed by the relocation control program 312 of the storage apparatus 300.

The storage apparatus 300 first executes Steps S102 to S107 to process one virtual area (VSEG) at a time in descending order of access frequency (for example, IOPS), and this is repeated until every VSEG is processed (S111).

In the loop processing, the current location (the real area ID 3154) and relocation destination determination result 3157 of the VSEG that is being processed are obtained from the virtual volume management information 315, and the current location is compared to the relocation destination (S102). In the case where it is found as a result of the comparison that the current location and the relocation destination are in the same tier, data relocation is unnecessary and the data relocation processing is ended. In the case where it is found that the current location and the relocation destination are in different tiers, on the other hand, Step S103 and subsequent relocation steps are executed.

Whether the relocation destination has a free area is then determined (S103). In the case where it is determined that the relocation destination has a free area, data of the VSEG is migrated to the free area (S104).

In the case where the relocation destination does not have a free area, on the other hand, whether the relocation destination has a replaceable area is determined (S105). In the case where the relocation destination is storing data that can be placed in a lower tier, it is determined that the relocation destination has a replaceable area, and a free area is created by storing in a lower tier the data that can be cleared out of the relocation destination (S106). In the case where the relocation destination has no replaceable area, on the other hand, a search is conducted for another tier that is closest to the relocation destination in performance, and the data of the VSEG is migrated to the other layer found by the search (S107).

The configuration of the file server 100 is described next.

<Logical Configuration of the File Server>

The file management program 111 provides a function of building the file system 121 based on the file management information 115 and on the file server configuration information 1114, and a function of associating a page in a file with a VSEG in a logical volume.

The file relocation control program 112 provides a function of obtaining the relocation destination of a file that is being processed from the policy settings information 113 and the file management information 115, and relocating the file.

(i) File Management Information

FIG. 10 is a diagram for illustrating an example of a configuration of the file management information 115, which is used to manage files.

In each entry of the file management information 115, a file length 1151, a device ID 1152, a user ID 1153, a node ID 1154, a file mode 1155, a last update date/time 1156, and a last reference date/time 1157 are managed in association with one another.

The file length 151 is the length (byte count) of a file. The device ID 1152 is identification information for uniquely identifying a logical volume where the file is stored. The user ID 1153 is information indicating the owner of the file. The node ID 1154 is identification information for identifying the file uniquely throughout the file system. The file mode 1155 is information indicating access right (for example, write, read, or execution) that is set to the file. The last update date/time 1156 is a date/time at which the file is updated last. The last reference date/time 1157 is a date/time at which the file is referred to last.

The file management information 115 is updated when a file is accessed. The file management information 115 may include information indicating the characteristics of a file in addition to the information described above.

(ii) File Server Configuration Information (FIG. 11)

FIG. 11 is a diagram for illustrating an example of a configuration of the file server configuration information 114, which is used to manage the configuration of the file server 100.

In each entry of the file server configuration information 114, a logical volume ID 1141 and a virtual volume ID 1142 are managed in association with each other.

The logical volume ID 1141 is identification information for uniquely identifying a logical volume of the file server 100. The virtual volume ID 1142 is identification information for uniquely identifying a virtual volume in the storage apparatus 300 that corresponds to the logical volume.

File relocation control described later uses at least two logical volumes.

(iii) Policy Settings Information (FIG. 12)

FIG. 12 is a diagram for illustrating an example of a configuration of the policy settings information 113 in which policies used for file relocation control are managed.

In each entry of the policy settings information 113, a policy ID 1131, a search criterion 1132, current settings 1133, change unnecessity check 1134, a relocation destination 1135, and a relocation condition 1136 are managed in association with one another.

The policy ID 1131 is identification information for uniquely identifying a policy. The search criterion 1132 is a condition of a file to which the policy is to be applied. A file name may be specified as the search criterion 1132, or meta data (for example, the creator or the date of creation) of a file may be set as the search criterion 1132. The current settings 1133 are information indicating the settings of a file that is to be relocated under the policy, and examples of the settings include “depends on the file” (file relocation is executed) and “depends on the block” (a logical volume is fixed instead of executing file relocation).

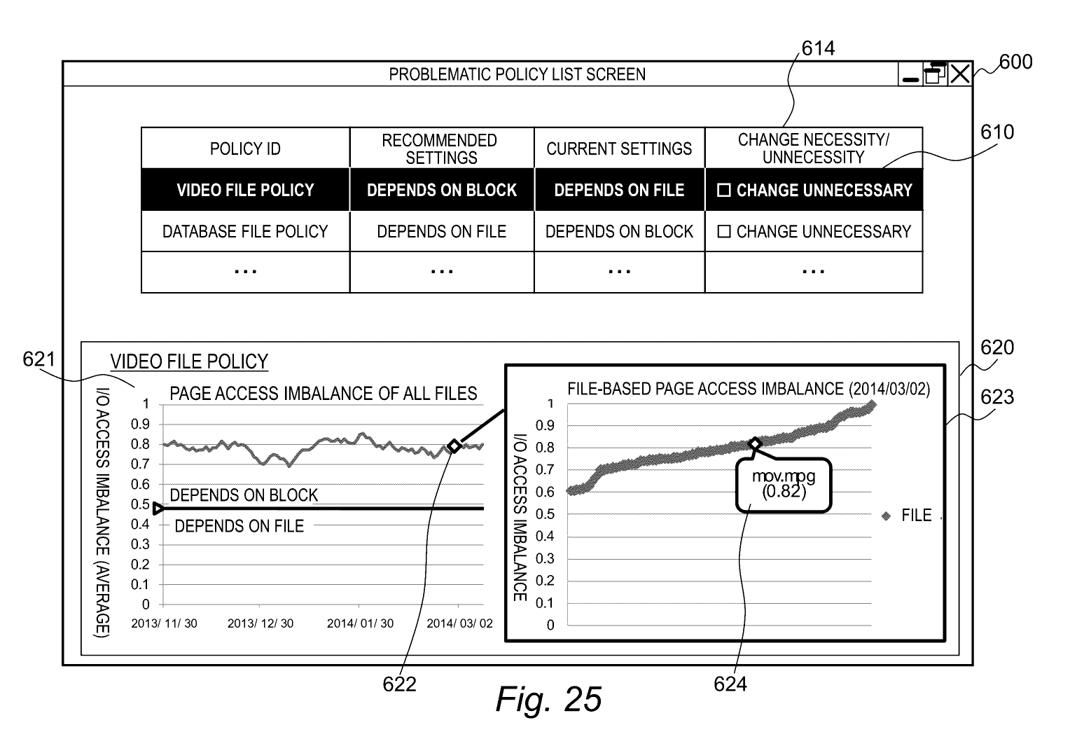

The change unnecessity check 1134 is a flag for controlling whether the policy is to be displayed as a problematic policy on a policy management screen illustrated in FIG. 25, and the value of the change unnecessity check 1134 is entered by the user on the policy management screen. Specifically, in the case where the change unnecessity check 1134 is set to “false”, the policy is not displayed as a problematic policy on the policy management screen and file location is therefore not changed. The relocation destination 1135 is identification information of a logical volume that serves as the relocation destination of a file that fulfills the relocation condition. The relocation condition 1136 is a condition for executing relocation by the file relocation control program 112 in the case where settings for executing file relocation are set, and is set for each relocation destination separately. Specifically, in the case where a file that meets the search criterion 1132 fulfills the relocation condition 1136, the file is placed in the relocation destination 1135.

The items of the policy settings information 113 may be set in advance as fixed values, or may have arbitrary values set by the management server 200. For example, relocation to a high performance logical volume if I/O access is made even once and relocation to a low performance logical volume if there is no I/O access for fourteen days may be set as default values to the relocation condition 1136. A relocation condition may also be created by using the information stored in the file management information 115.

<Processing by the File Server>

FIG. 13 is a flow chart of file relocation control processing. The relocation control processing is executed by the file relocation control program 112 of the file server 100.

The file server 100 first obtains all policies from the policy settings information 113. The file server 100 then executes Steps S112 to S119 repeatedly until every obtained policy is processed (S111).

In outer loop processing, a search criterion of the obtained policy that is being processed is used to search the file system 121 and obtain a list of files to which the policy is to be applied (S112). Steps S114 to S119 are then executed repeatedly until every file on the obtained list is processed (S113).

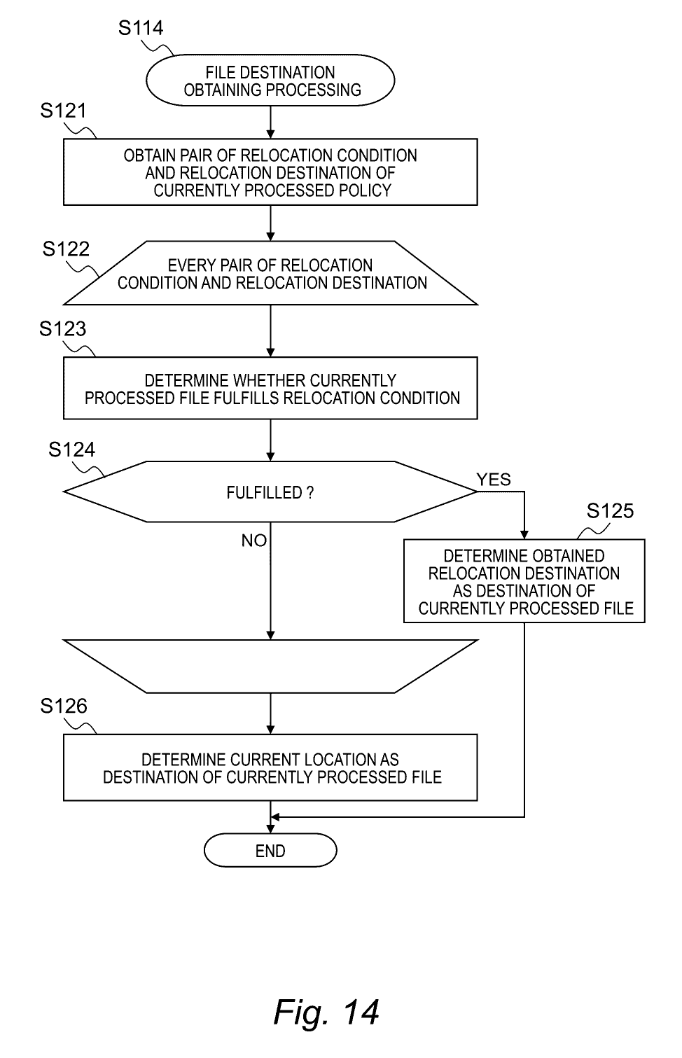

In inner loop processing, the relocation destination of the file that is being processed is obtained from the policy settings information 113 (S114). Details of Step S114 are described later with reference to FIG. 14. The current location of the currently processed file is obtained from file system configuration information (not shown). The current location and the relocation destination are then compared (S115). In the case where the current location and the relocation destination are in the same tier, the file does not need to be relocated and the file relocation processing is ended. In the case where the current location and the relocation destination are in different tiers, on the other hand, Step S116 and subsequent relocation steps are executed.

Whether the relocation destination has a free area is then determined (S116). In the case where it is determined that the relocation destination has a free area, the file is migrated to the free area (S117).

In the case where there is no free area at the relocation destination, on the other hand, whether the relocation destination has a replaceable area is determined (S118). In the case where the relocation destination is storing a file that can be placed in a lower tier, it is determined that the relocation destination has a replaceable area, and a free area is created by storing in a lower tier the file that can be cleared out of the relocation destination (S119). In the case where the relocation destination has no replaceable area, on the other hand, this file cannot be relocated and the file relocation processing is ended. Alternatively, In the case where there is no replaceable area, a search may be conducted for another tier that is closest to the relocation destination in performance to migrate the file to the other layer found by the search.

FIG. 14 is a flow chart of the processing of obtaining the relocation destination of a file in which details of Step S114 are illustrated.

The file server 100 first obtains from the policy settings information 113 pairs of the relocation condition 1136 and relocation destination 1135 of the currently processed policy. Steps S123 to S126 are then executed repeatedly until every obtained pair is processed (S122).

In the loop processing, whether the currently processed file fulfills a relocation condition is determined for the pair that is being processed (S123).

In the case where the currently processed file fulfills a relocation condition, the obtained relocation destination is determined as the destination of the currently processed file (S125). In the case where the currently processed file fulfills none of relocation conditions, the current location is determined as the destination of the currently processed file (S126).

Relocation between tiers is hidden to the outside of the file server 100. For example, after relocation between tiers is executed for a file, a user of the file can still access that same file as before the relocation without being conscious of the location of the file.

The configuration of the management server 200 is described next.

<Logical Configuration of the Management Server>

An example of the logical configurations of the memory 202 and the auxiliary storage device 203 on the management server 200 is described first with reference to FIG. 3.

As described above, the memory 202 stores the problematic policy searching program 211, the page access imbalance obtaining program 212, the problematic policy management information 213, the page access imbalance (file-based) information 214, the feature amount and threshold information 215, and the virtual volume management information (for management) 216. The auxiliary storage device 203 stores the page access imbalance (policy-based) time-series information 221 and the page access imbalance (file-based) time-series information 222.

(i) Problematic Policy Management information

FIG. 15 is a diagram for illustrating an example of a configuration of the problematic policy management information 213, which is used to present a problematic policy to the user.

In each entry of the problematic policy management information 213, a policy ID 2131, recommended settings 2132, current settings 2133, and change unnecessity check 2134 are managed in association with one another.

The policy ID 2131 is identification information for uniquely identifying a policy. The recommended settings 2132 are information indicating settings that are recommended by the management server 200. The current settings 2133 are information indicating the current settings of the policy. The change unnecessity check 2134 is information indicating whether the user has entered an instruction “change is unnecessary”.

(ii) Page Access Imbalance (File-Based) Information

FIG. 16 is a diagram for illustrating an example of a configuration of the page access imbalance (file-based) information 214.

In each entry of the page access imbalance (file-based) information 214, a file ID 2141 and page access imbalance 2142 are managed in association with each other.

The file ID 2141 is identification information for uniquely identifying a file. The page access imbalance 2142 is a value that is obtained by the page access imbalance obtaining program 212 and that indicates whether page access is unbalanced in the file.

(iii) Feature Amount and Threshold Information

FIG. 17 is a diagram for illustrating an example of a configuration of the feature amount and threshold information 215, which is used by the problematic policy searching program 211 to obtain recommended settings.

In each entry of the feature amount and threshold information 215, a feature amount ID 2151, a threshold 2152, par/above-threshold recommended settings 2153, and under-threshold recommended settings 2154 are managed in association with one another.

The feature amount ID 2151 is identification information for uniquely identifying a feature amount. Examples of the feature amount include page access imbalance and a change of a hot spot. Other values than those that represent the characteristics of a file may be used as the feature amount. The threshold 2152 is a threshold for switching between the recommended settings 2153 and the recommended settings 2154. The par/above-threshold recommended settings 2153 are settings that are recommended when the feature amount is equal to or more than the threshold. The under-threshold recommended settings 2154 are settings that are recommended when the feature amount is less than the threshold.

(iv) Page Access Imbalance (Policy-Based) Time-Series Information

FIG. 18 is a diagram for illustrating an example of a configuration of the page access imbalance (policy-based) time-series information 221, which is used to present a problematic policy to the user.

In each entry of the page access imbalance (policy-based) time-series information 221, a date/time 2211, a policy ID 2212, and page access imbalance 2213 are managed in association with one another.

The date/time 2211 is a date/time at which page access imbalance is obtained. The policy ID 2212 is identification information for uniquely identifying a policy. The page access imbalance 2213 is a value that is obtained by the page access imbalance obtaining program 212 and that indicates whether page access is unbalanced in a file.

(v) Page Access Imbalance (File-Based) Time-Series Information

FIG. 19 is a diagram for illustrating an example of a configuration of the page access imbalance (file-based) time-series information 222, which is used to present a problematic policy to the user.

In each entry of the page access imbalance (file-based) time-series information 222, a date/time 2221, a file ID 2222, and page access imbalance 2223 are managed in association with one another.

The date/time 2221 is a date/time at which page access imbalance is obtained. The file ID 2222 is identification information for uniquely identifying a file. The page access imbalance 2223 is a value that is obtained by the page access imbalance obtaining program 212 and that indicates whether page access is unbalanced in the file.

(vi) Virtual Volume Management Information (for Management)

FIG. 20 is a diagram for illustrating an example of a configuration of the virtual volume management information (for management) 216, which is used by the management server 200 to manage virtual volumes.

In each entry of the virtual volume management information (for management) 216, a virtual volume ID 2161, a page ID 2162, a virtual area ID 2163, an LBA range 2164, a real area ID 2165, an access count 2166, a monitoring period 2167, and a relocation destination determination result 2168 are managed in association with one another.

The page ID 2162 is identification information for uniquely identifying a page (a real area). Other items than the page ID 2162, namely, the virtual volume ID 2161, the virtual area ID 2163, the LBA range 2164, the real area ID 2165, the access count 2166, the monitoring period 2167, and the relocation destination determination result 2168 are the same as the virtual volume ID 3151, the virtual area ID 3152, the LBA range 3153, the real area ID 3154, the access count 3155, the monitoring period 3156, and the relocation destination determination result 3157, respectively, in the virtual volume management information 315.

The management server 200 obtains the association relation between a real area ID and a VSEG from the file server 100 repeatedly (for example, at given time intervals, e.g., once in a minute), and obtains the virtual volume management information 315 from the storage apparatus 300. The management server 200 stores the obtained association relation and information in the virtual volume management information (for management) 216.

<Processing by the Management Server>

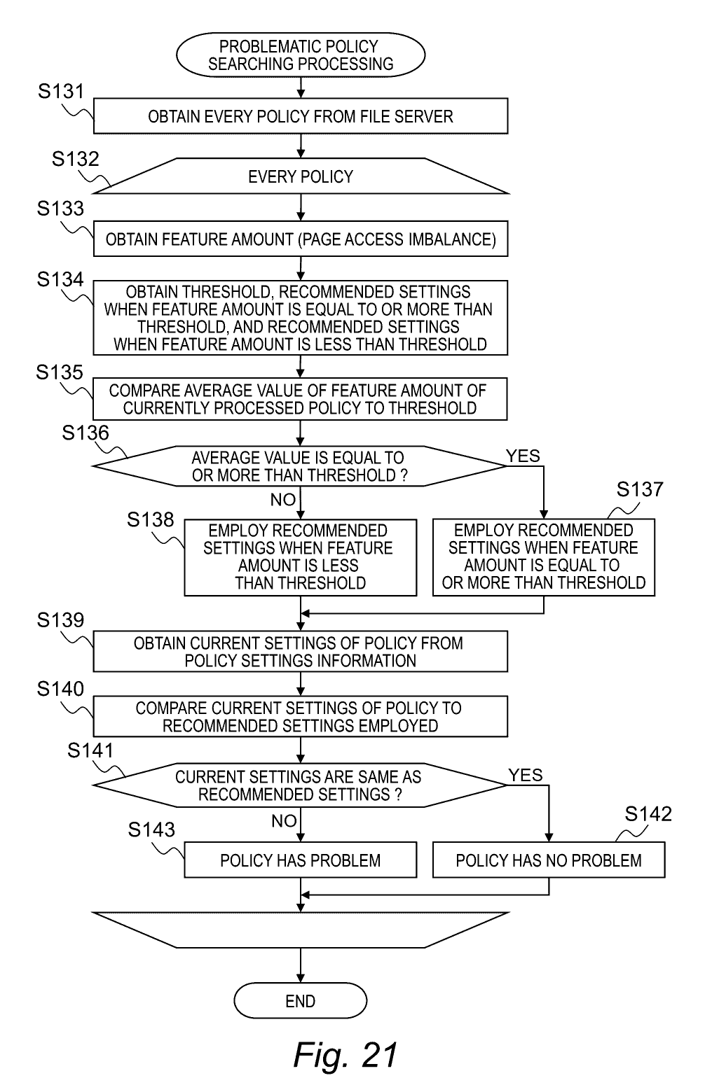

FIG. 21 is a flow chart of the problematic policy searching processing. The problematic policy searching processing is executed by the problematic policy searching program 211 repeatedly (for example, at given time intervals).

The management server 200 first obtains all policies held in the policy settings information 113 of the file server 100 (S131). Steps S133 to S143 are then executed repeatedly until every obtained policy is processed (S132).

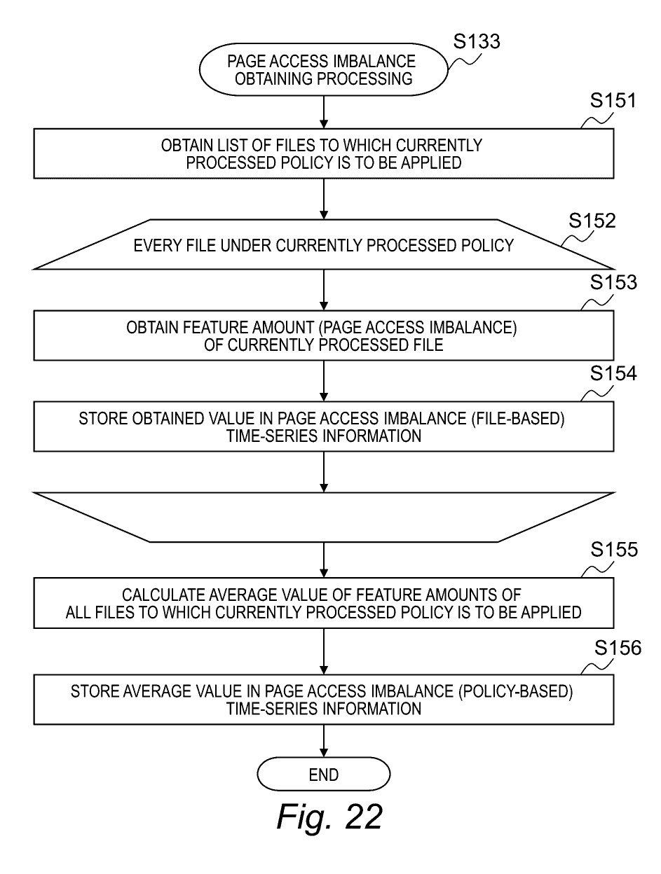

In the loop processing, an average value of page access imbalance is calculated for the obtained policy that is being processed (S133). The obtaining of page access imbalance is processing executed by the page access imbalance obtaining program 212, and is described in detail with reference to FIG. 22.

Thereafter, the threshold 2152, the par/above-threshold recommended settings 2153, the under-threshold recommended settings 2154 are obtained from the feature amount and threshold information 215 (S134). The average value calculated in Step S133 is then compared to the threshold obtained in Step S134 (S135). In the case where the average value is equal to or more than the threshold, par/above-threshold recommended settings are employed (S137). In the case where the average value is smaller than the threshold, on the other hand, under-threshold recommended settings are employed (S138).

The current settings of the policy are then obtained from the policy settings information 113 (S139) to be compared to the recommended settings employed (S140). In the case where it is found as a result of the comparison that the current settings are the same as the recommended settings, the current policy has no problem (S142), and the next policy is processed. The current policy, if recorded in the problematic policy management information 213, is deleted from the problematic policy management information 213. In the case where the current settings differ from the recommended settings, on the other hand, the current policy has a problem and is recorded in the problematic policy management information 213 (S143). At this point, “false” is stored as the change unnecessity check 2134.

A record in the problematic policy management information 213 can be deleted at the time the user changes the recorded policy. In the case where a record of the current policy in the problematic policy management information 213 is to be deleted in Step S142, the record is deleted from the problematic policy management information 213 in the case where it is determined in the next executed search processing that the policy has no problem.

FIG. 22 is a flow chart of the page access imbalance obtaining processing in which details of Step S133 are illustrated. The page access imbalance obtaining processing is executed by the page access imbalance obtaining program 212.

The management server 200 first obtains from the file server 100 a list of files to which the currently processed policy is to be applied (S151). Steps S153 and S154 are then executed repeatedly until every file on the obtained list is processed (S152).

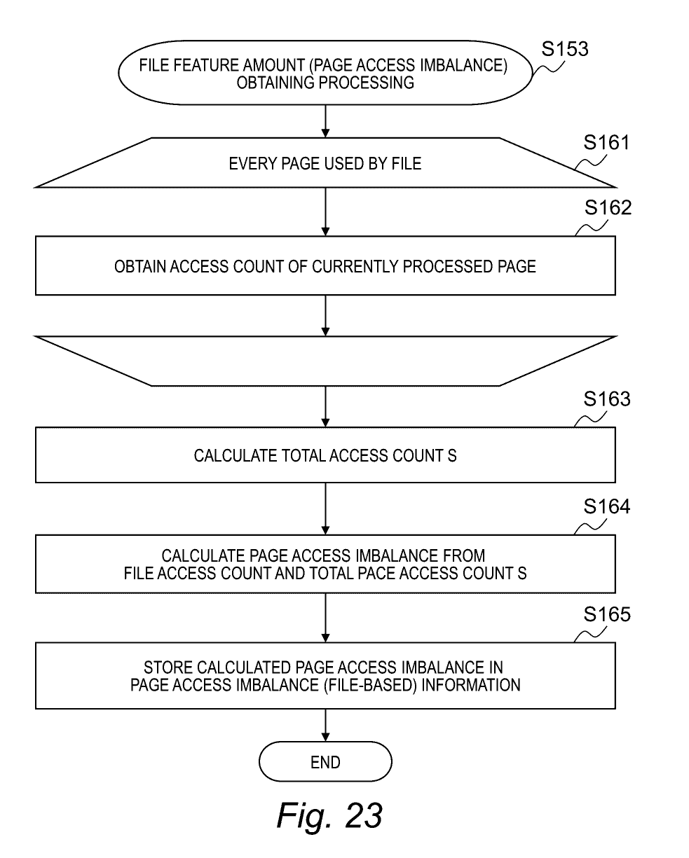

In the loop processing, the feature amount of the file that is being processed is obtained (S153). The feature amount of a file in the first embodiment is measured in the form of page access imbalance. Details of the processing of obtaining the feature amount are described later with reference to FIG. 23. The obtained page access imbalance is stored in the page access imbalance (file-based) time-series information 222 (S154).

After page access imbalance is obtained for every file, an average value of page access imbalance of all files to which the currently processed policy is to be applied is calculated (S155). The calculated average value is stored in the page access imbalance (policy-based) time-series information 221 (S156).

An example of how an average value of page access imbalance is calculated in Step S155 is described. The management server 200 initializes a variable that represents the sum (for example, “sum”) to 0. The management server 200 next obtains from the page access imbalance (file-based) time-series information 222 the values of the page access imbalance 2223 of all files to which the currently processed policy is to be applied, and adds the obtained values to the variable sum. After the processing is finished for all of the files, the variable sum is divided by the number of the files to calculate the average value.

FIG. 23 is a flow chart of the processing of obtaining page access imbalance of a file in which details of Step S153 are illustrated. The file page access imbalance obtaining processing is executed by the page access imbalance obtaining program 212.

The management server 200 first obtains from the file server 100 a list of pages (real areas) that are used by the currently processed file. Step S162 is then executed repeatedly until every page on the obtained list is processed (S161). In the loop processing, the access count of the page that is being processed is obtained from the virtual volume management information (for management) 216 (S162).

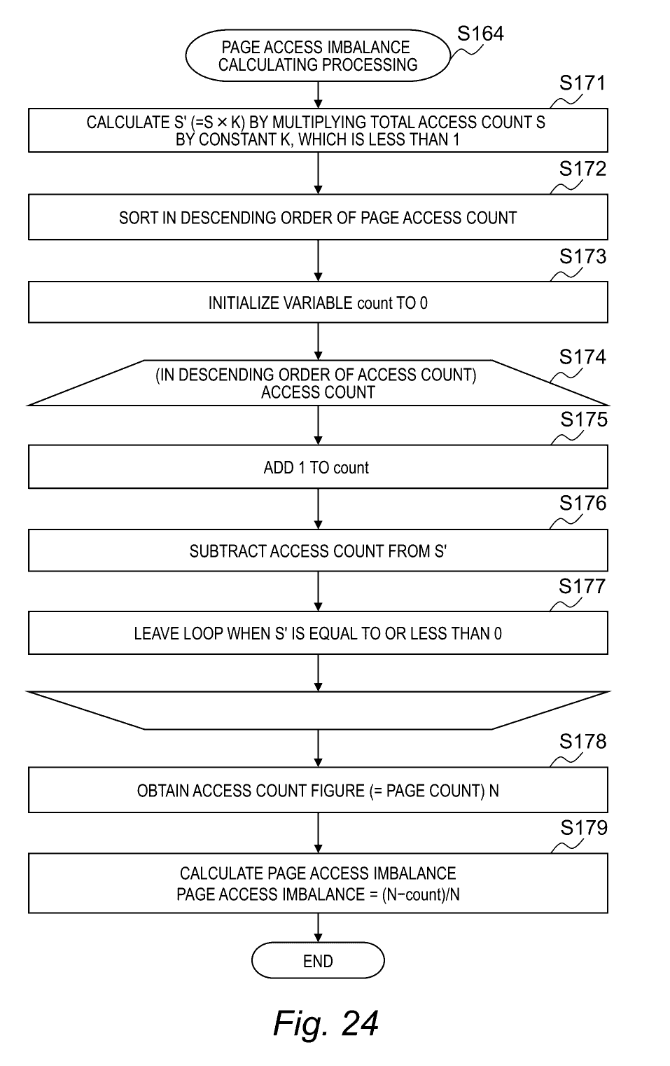

After the access count is obtained for every page, a total access count S of the pages used by the file is calculated (S163). Page access imbalance is calculated from the access count of the file and from the total access count S of the pages (S164). Details of the processing of calculating page access imbalance are described later with reference to FIG. 24. The calculated page access imbalance is stored in the page access imbalance (file-based) information 214 (S165).

FIG. 24 is a flow chart of the processing of calculating page access imbalance from the access count and from the total access count S in which details of Step S164 are illustrated. Page access imbalance is calculated by the following expression:

Page access imbalance=(file page count N−minimum value “count” of the number of pages that have an access count equal to or higher than S′)/file page count N

The management server 200 first multiplies the total access count S by a constant K, which is smaller than 1, to calculate the variable S′=S×K (S171). The management server 200 sorts the access counts of pages of the currently processed file in descending order of access count (S172), and initializes the variable count for counting the minimum page count to 0 (S173). Steps S175 to S177 are then executed to process one page at a time in descending order of access count, and this processing is repeated until every page of the file is processed (S174).

In the loop processing, 1 is added to the variable count (S175), the access count of the page that is being processed is obtained from the virtual volume management information (for management) 216 and is subtracted from S′ (S176). When the variable S′ reaches 0 or less, the management server 200 leaves the loop processing (S177).

After the loop processing is ended, the number of access counts (i.e., the number of pages) N is obtained (S178), and page access imbalance is calculated (S179).

Through the processing described above, the page count of pages having an access count the proportion of which to the total access count is equal to the constant K (namely, page access imbalance) can be obtained.

FIG. 25 is a diagram for illustrating an example of a screen on which a list of problematic policies is presented to the user.

A problematic policy list screen 600 includes an area in which a problematic policy list 610 is displayed and an area 620 in which detailed information of a policy selected by the user is displayed. The problematic policy list 610 displays information obtained from the problematic policy management information 213. Only policies for which “false” is set to the change unnecessity check 2134 are displayed in the problematic policy list 610, and policies for which “true” is set are not displayed. In the case where the user checks a checkbox for change necessity/unnecessity 614 of one policy in the problematic policy list 610, “true” is stored as the change unnecessity check 2134 of this policy in the problematic policy management information 213, and the policy is deleted from the problematic policy list 610.

When the user selects one policy from the problematic policy list 610, the management server 200 displays time-series information obtained from the page access imbalance (policy-based) time-series information 221 on the screen (621). In the screen of FIG. 25, a video file policy is selected.

When the user further selects a point in time in the time-series information (622), the management server 200 displays on the screen the page access imbalance of each file at the selected time point which is obtained from the page access imbalance (file-based) time-series information 222 (623). When a mouse cursor is pointed to a file on a file-based page access imbalance screen 623, the file name and page access imbalance value of the pointed file are displayed (624).

In the case where a policy has “depends on the file” settings, details of the policy may be displayed. In this case, the management server 200 holds detailed information of the policy or obtains information of the policy from the policy settings information 113 of the file server 100 to display the information.

In the first embodiment, a policy of storing all pieces of data of a file in an upper tier may be recommended to a file that does not match a policy to be applied to the file if stored in a lower tier. A policy of storing data of a file in a lower tier may be recommended to a file that still matches a policy to be applied to the file if stored in a lower tier. A policy of stopping block relocation and placing all blocks that make up a file in an upper tier may be recommended to a file that requires a level of performance that only the upper tiers can provide. In this manner, a tier that is not overqualified nor underqualified for a policy to be applied to a file can be selected for the file.

A file having page access imbalance that is within a given range from the average value, or a file having page access imbalance that is outside this range, may be selected and a new policy may be recommended to the selected file.

A policy of storing a file in an upper tier and a policy of storing a file in a lower tier may both be displayed. By displaying a policy about an upper tier and a policy about a lower tier both, many policies can be presented to the administrator as options to select from.

As described above, according to the first embodiment, the frequency of page access (the I/O count per unit time) is obtained for pages where pieces of data that make up a file are stored, a policy applied to the file is compared to the imbalance in the frequency of access to some of the pieces of data that make up the file, and, in the case where it is found as a result of the comparison that the policy applied to the file needs to be changed, the changed policy is output. This enables the administrator who has had difficulties in checking policies because there are too many files to easily find a problem with a policy and the cause of the problem. In addition, modifying a policy improves the utilization efficiency of the storage apparatus. The administrator can also determine, from file access imbalance, which of file-based relocation and page-based relocation is appropriate.

Another advantage is that, because the frequency of access to a page is obtained on a file-by-file basis, access frequency imbalance can be calculated for each file separately.

In addition, access frequency imbalance can be obtained by simple calculation because a minimum value of the number of pages where the access frequency obtained for each page is at a given proportion or higher to the combined access count of all pages of the file in question is obtained, and a value calculated by dividing the obtained minimum page count by the total page count is used as access frequency imbalance.

### Second Embodiment

A second embodiment of this invention uses other feature amounts than page access imbalance (for example, a change of a hot spot) in the problematic policy searching processing of the first embodiment (FIG. 21). A hot spot is a page (a real area) that is being accessed concentratedly. Specifically, the second embodiment enables the user to set an appropriate policy by evaluating a change of a hot spot, or by evaluating page access imbalance and a change of a hot spot. With a plurality of types of feature amount employed, the user can set a policy through an evaluation of a plurality of types of information.

In the second embodiment, which is a modification example of the first embodiment, only differences in configuration and processing from the first embodiment are described, and a description on configurations and processing that are the same as the ones in the first embodiment is omitted.

Feature amounts obtained in the second embodiment for the page access imbalance obtaining processing of the first embodiment (FIG. 22) include a change of a hot spot in addition to page access imbalance.

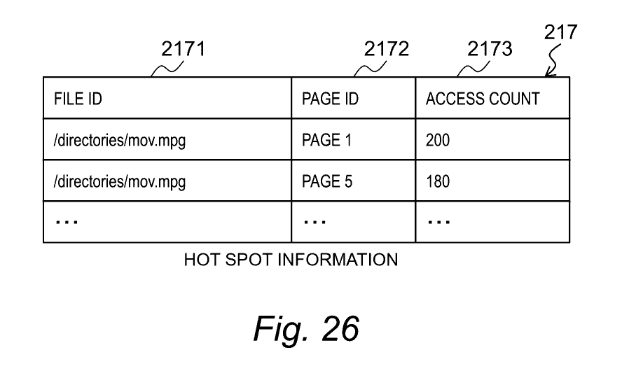

FIG. 26 is a diagram for illustrating an example of a configuration of hot spot information 217, which is used to manage hot spots. The hot spot information 217 is stored in the memory 202 of the management server 200.

In each entry of the hot spot information 217, a file ID 2171, a page ID 2172, and an access count 2173 are managed in association with one another.

The file ID 2171 is identification information for uniquely identifying a file. The page ID 2172 is identification information for uniquely identifying a page (a real area) that is being accessed concentratedly. The access count 2173 is the number of times the page has been accessed.

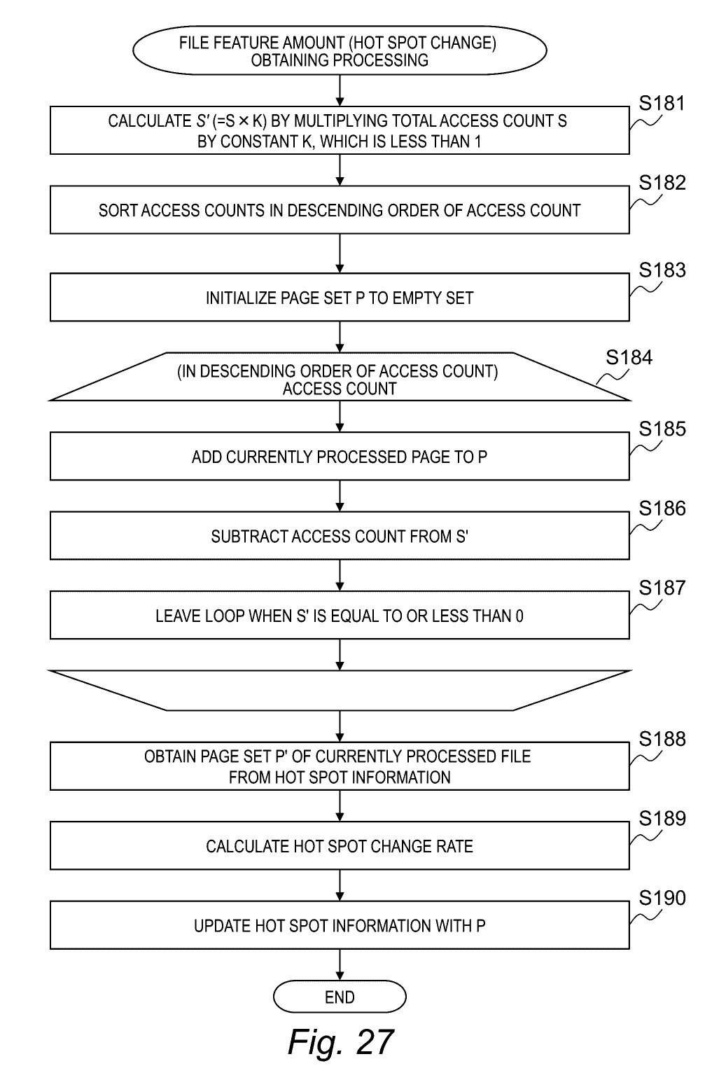

FIG. 27 is a flow chart of hot spot change obtaining processing. A change of a hot spot is calculated by the following expression:

Hot spot change=1−(the number of pages that are both a previous hot spot page and the current hot spot page/the number of previous hot spot pages)

The management server 200 first multiplies the total access count S by the constant K, which is smaller than 1, to calculate the variable S′=S×K (S181). The access counts of pages of the currently processed file are sorted in descending order of access count (S182), and a page set P for compiling hot spot changes is initialized to an empty set (S183). Steps S185 to S187 are then executed to process one page at a time in descending order of access count, and this processing is repeated until every page of the file is processed (S184).

In the loop processing, the page that is being processed is added to the page set P (S185), and the access count of the currently processed page is obtained from the virtual volume management information (for management) 216 and is subtracted from S′ (S186). In the case where the variable S′ reaches 0 or less, the management server 200 leaves the loop processing (S187).

After the loop processing is ended, a previous hot spot P′ is obtained from the hot spot information 217 (S188), and the rate of change of the hot spot is calculated (S189). The hot spot change rate is calculated by 1−(|PΛP′|/|P′|), where |P| represents the page count of P.

The hot spot information 217 is then updated with the calculated page set P (S190).

As described above, according to the second embodiment, a diversity of policies can be recommended by evaluating a change of a hot spot. Specifically, in the case where the rate of change of a hot spot is greater than a given threshold, a policy of placing a file in question in an upper tier without executing block-based relocation is recommended. A hot spot change rate that is greater than the given threshold indicates that a file is accessed frequently in a plurality of places. The access performance of the file is therefore improved more by not executing block-based relocation.

### Third Embodiment

A third embodiment of this invention uses as a feature amount a value that is input by the user (for example, a minimum guaranteed IOPS value), in addition to page access imbalance, in the problematic policy searching processing of the first embodiment. In short, a value input by the user is used in the third embodiment. By using, for example, a minimum guaranteed IOPS value in addition to page access imbalance, the management server 200 can determine whether an upper tier needs to be allocated preferentially to a virtual area, or a lower tier is to be allocated to a virtual area. The intent of the user can be reflected on a search for problematic policies in this manner.

In the third embodiment, which is a modification example of the first embodiment, only differences in configuration and processing from the first embodiment are described, and a description on configurations and processing that are the same as the ones in the first embodiment is omitted.

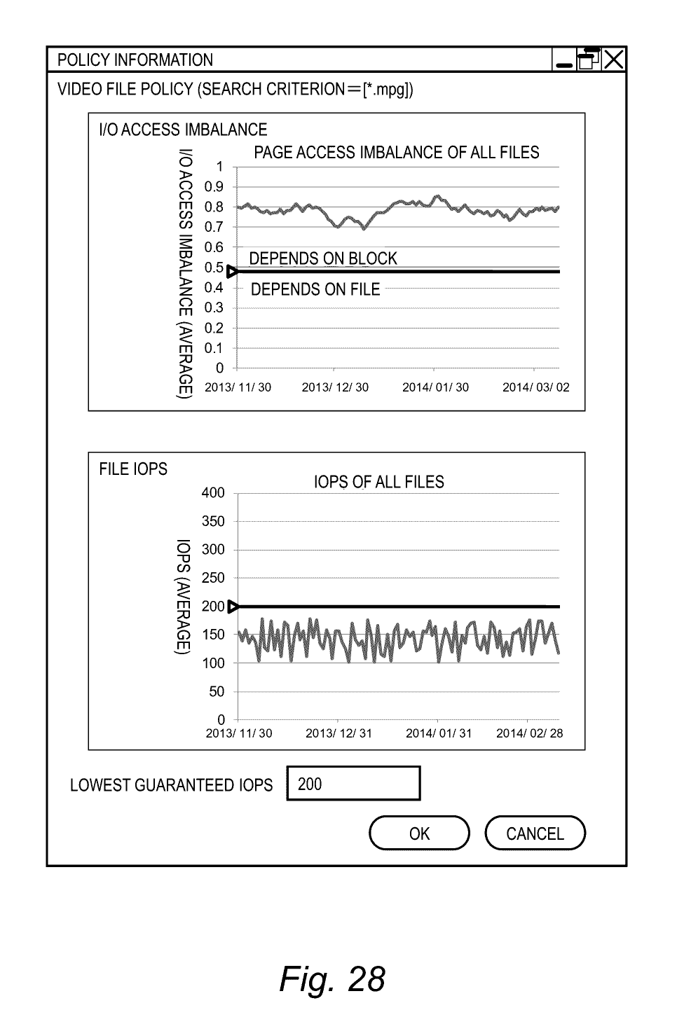

FIG. 28 is a diagram for illustrating an example of a screen on which the user enters a minimum guaranteed IOPS value in this embodiment.

The user can update the minimum guaranteed IOPS value of a policy in question by entering new minimum guaranteed IOPS. The user can also check time-series information about the feature amount of the policy in question.

In the case where the minimum guaranteed IOPS exceeds the IOPS of a lower tier, a recommended policy of using an upper tier is output in the problematic policy searching processing.

In the third embodiment, a recommended policy may be output in the case where it is found as a result of comparison between a minimum guaranteed IOPS value of a file that is managed by the file server 100 and the IOPS of the file that a policy applied to the file needs to be changed. This way, a policy under which necessary IOPS is fulfilled can be recommended.

As described above, according to the third embodiment, a policy that takes into account which tier is to be allocated to a virtual area can be recommended by using minimum guaranteed IOPS. For example, a policy of storing a file in a lower tier can be recommended to a file that is smaller in IOPS than a given threshold. A situation in which files low in IOPS occupy an upper tier can thus be prevented.

This invention is not limited to the above-described embodiments but includes various modifications. The above-described embodiments are explained in details for better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, processing modules, and processing means, for all or a part of them, may be implemented by hardware: for example, by designing an integrated circuit, and may be implemented by software, which means that a processor interprets and executes programs providing the functions.

The information of programs, tables, and files to implement the functions may be stored in a storage device such as a memory, a hard disk drive, or an SSD (a Solid State Drive), or a storage medium such as an IC card, or an SD card.

The drawings illustrate control lines and information lines as considered necessary for explanation but do not illustrate all control lines or information lines in the products. It can be considered that almost of all components are actually interconnected.

What is claimed is:

1. A management server, comprising:
a memory;
a processor configured to access to the memory; and
a network interface through which the management server holds communication to/from a storage apparatus and a file server,
wherein the storage apparatus includes a storage device, which is divided into pages each having a determined capacity to store data,
wherein the file server is configured to manage, on a file-by-file basis, data that is stored in the storage apparatus, and
wherein the processor is configured to:
obtain an I/O count per unit time of access to pages which stores data contained in the file; and
compare a policy applied to the file and imbalance in I/O to a part of the data contained in the file, and output a changed policy in the case where it is found that the policy applied to the file needs to be changed as a result of the comparison.

2. The management server according to claim 1, wherein the processor is configured to obtain the I/O count per unit time of access to pages on a file-by-file basis.

3. The management server according to claim 2,
wherein the processor is configured to:
obtain a minimum value of a number of pages out of combinations of pages where a proportion of the I/O count per unit time obtained for each page to a combined I/O count per unit time of all pages of the file is equal to or more than a determined value; and
calculate, as I/O imbalance, a value by dividing the obtained minimum value of the number of pages by a total page count.

4. The management server according to claim 1, wherein the processor is configured to:
receive a management index of an I/O count per unit time of a file managed by the file server;
obtain the I/O count per unit time of the file; and
output a recommended policy that is changed from a policy applied to the file in the case where it is found that the applied policy needs to be changed as a result of comparison between the received management index and the I/O count per unit time of the file.

5. The management server according to claim 1,
wherein the storage apparatus includes a first storage device and a second storage device, which is lower in I/O performance than the first storage device, and
wherein the processor is configured to:
receive a policy to be applied to the file;
output a policy of storing data contained in the file in the first storage device in the case where the file fails to match the applied policy when data contained in the file are stored in the second storage device; and
output a policy of storing data contained in the file in the second storage device in the case where the file matches the applied policy when the data contained in the file are stored in the second storage device.

6. The management server according to claim 1,
wherein the storage apparatus includes a first storage device and a second storage device, which is lower in I/O performance than the first storage device, and
wherein the processor is configured to:
receive a policy to be applied to the file; and
output a policy of storing all data contained in the file in the first storage device, instead of a policy of storing the data contained in the file in the first storage device on a page-by-page basis, in the case where the file fails to match the applied policy when the data contained in the file are stored in the second storage device.

7. The management server according to claim 1,
wherein the storage apparatus includes a first storage device and a second storage device, which is lower in I/O performance than the first storage device, and
wherein the processor is configured to output both a policy of storing data contained in the file in the first storage device and a policy of storing the data contained in the file in the second storage device.

8. The management server according to claim 1,
wherein the storage apparatus includes a first storage device and a second storage device, which is lower in I/O performance than the first storage device, and
wherein the processor is configured to:
obtain an I/O count per unit time of the file; and
output a policy of storing the file in the second storage device in the case where the obtained I/O count of the file is less than a determined threshold.

9. The management server according to claim 1, wherein the management server is configured to:
obtain information about a hot spot in the file; and
output a policy of stopping page-based relocation in the case where a rate of change of the hot spot in the file is greater than a determined threshold.

10. A storage system, comprising:
a storage apparatus including a storage device, which is divided into pages each having a determined capacity to store data;
a file server configured to manage, on a file-by-file basis, data that is stored in the storage apparatus; and
a management system coupled to the storage apparatus and the file server,
wherein the management system includes at least one memory, at least one processor configured to access to the at least one memory, and at least one network interface, and
wherein the management system is configured to:
obtain an I/O count per unit time of access to pages which stores data contained in the file; and
compare a policy applied to the file and imbalance in I/O to a part of the data contained in the file, and output a changed policy in the case where it is found that the policy applied to the file needs to be changed as a result of the comparison.

11. The storage system according to claim 10, wherein the management system is configured to obtain the I/O count per unit time of access to pages on a file-by-file basis.

12. The storage system according to claim 11, wherein the management system is configured to:
obtain a minimum value of a number of pages where a proportion of the I/O count per unit time obtained for each page to a combined I/O count per unit time of all pages of the file is equal to or more than a determined value; and
calculated, as I/O imbalance, a value by dividing the obtained minimum value of the number of pages by a total page count.
